(19) United States
(12) Patent Application Publication
(10) Pub. No.: US 2014/0176421 A1
(43) Pub. Date: Jun. 26, 2014

(54) DISPLAYING METHOD FOR FLEXIBLE DISPLAY DEVICE AND FLEXIBLE DISPLAY DEVICE USING THE SAME

(71) Applicant: Industrial Technology Research Institute, Hsinchu (TW)

(72) Inventor: Chih-Jen Chen, Tainan City (TW)

(21) Appl. No.: 13/932,010

(22) Filed: Jul. 1, 2013

(30) Foreign Application Priority Data
Dec. 24, 2012 (TW) 101149630

(51) Int. Cl. G06F 3/01

(52) U.S. Cl. CPC G06F 3/01
USPC 345/156

(57) ABSTRACT

A displaying method of a flexible display device and the flexible display device using the method are provided. The displaying method includes: displaying at least one object on a displaying area of the flexible display device; detecting a display mode of the flexible display device and generating display mode information; determining if at least one second object in the at least one object is displayed on a separation line according to the display mode information; rearranging the at least one object in the displaying area according to the display mode information if the at least one second object is displayed on the separation line. Accordingly, the arranging of the at least one object fits the need of users.

### CROSS-REFERENCE TO RELATED APPLICATION

This application claims the priority benefit of Taiwan application serial no. 101149630, filed on Dec. 24, 2012. The entirety of the above-mentioned patent application is hereby incorporated by reference herein and made a part of this specification.

### BACKGROUND

1. Technical Field

The disclosure relates to a displaying method for a flexible display device and a flexible display device using the same.

2. Related Art

Along with development of technology, displays are developed to become thin and flat. In recent years, flexible display devices are quickly developed. Since the flexible display device can be bent to occupy relatively less space, it is portable. Moreover, when the flexible display device is used, it can be spread from a bending state to a flat state or bent to other shapes to increase an application level of the display.

In order to achieve a man-machine interface suitable for usage and achieve more intuitive interaction, a plurality of sensors are configured to the flexible display device. The sensors can be used to detect bending and touch operations performed on the flexible display device by the user. Therefore, it is an important issue concerned by related technicians to provide user-friendly interaction according to the above operations.

### SUMMARY

The disclosure is directed to a displaying method of a flexible display device and a flexible display device using the same.

An exemplary embodiment of the disclosure provides a displaying method of a flexible display device, which includes following steps. At least one object is displayed on a display area of the flexible display device. A display mode of the flexible display device is detected to generate display mode information. It is determined whether at least one second object in the at least one object is displayed on a separation line according to the display mode information, and the at least one object is rearranged on the display area according to the display mode information when the at least one second object is displayed on the separation line, so as to avoid displaying the at least one object on the separation line.

According to another aspect, an exemplary embodiment of the disclosure provides a flexible display device including a display unit, a display deformation sensor and a processor. The processor is coupled to the display unit and the display deformation sensor, and displays at least one object on a display area of the display unit. The processor detects a display mode of the flexible display device through the display deformation sensor to generate display mode information. The processor determines whether at least one second object in the at least one object is displayed on a separation line according to the display mode information, and rearranges the at least one object on the display area according to the display mode information when the at least one second object is displayed on the separation line, so as to avoid displaying the at least one object on the separation line.

In order to make the aforementioned and other features and of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a flowchart illustrating a displaying method according to an exemplary embodiment of the disclosure.

FIG. 1B is a block diagram of a flexible display device according to an exemplary embodiment of the disclosure.

FIG. 2 is a schematic diagram of a bended flexible display device according to an exemplary embodiment of the disclosure.

FIG. 3 and FIG. 4 are schematic diagrams of rearranging objects according to an exemplary embodiment of the disclosure.

FIG. 5 is a schematic diagram of moving all of the objects to a same sub area according to an exemplary embodiment of the disclosure.

FIG. 6 and FIG. 7 are schematic diagrams of objects implemented as characters according to an exemplary embodiment of the disclosure.

FIG. 8A and FIG. 8B are schematic diagrams illustrating a situation when the flexible display device is bended according to an exemplary embodiment of the disclosure.

FIG. 9 is a flowchart illustrating a displaying method according to an exemplary embodiment of the disclosure.

### DETAILED DESCRIPTION OF DISCLOSED EMBODIMENTS

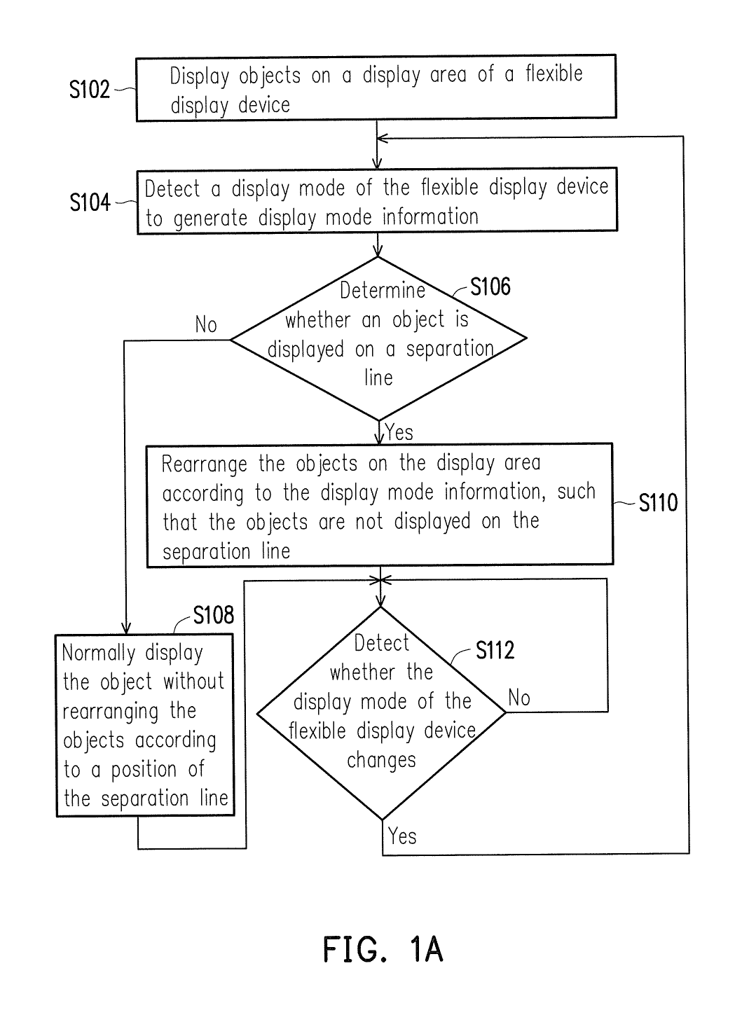

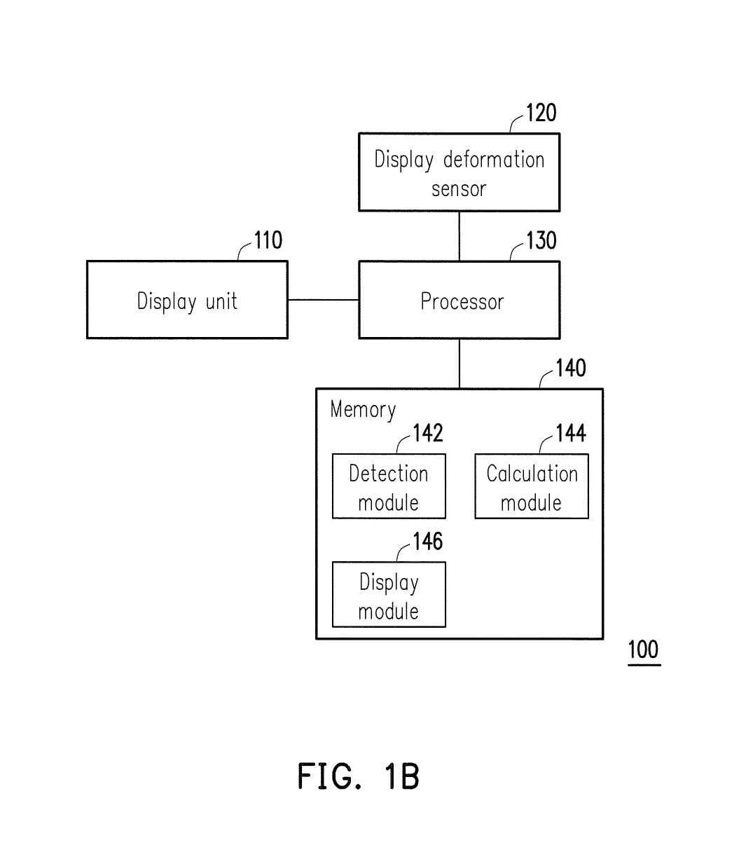

FIG. 1A is a flowchart illustrating a displaying method according to an exemplary embodiment of the disclosure.

According to the displaying method of the disclosure, after objects are displayed on a display area of a flexible display device (S102), a display mode of the flexible display device is detected to generate display mode information (S104). Moreover, in the displaying method of the disclosure, it is further determined whether an object (which is also referred to as a second object) in the objects is displayed on a separation line according to the display mode information (S106). If the second object is displayed on the separation line, the objects are rearranged (or re-typeset) on the display area according to the display mode information, such that the objects are not displayed on the separation line (S110). Moreover, it is continually detected whether the display mode of the flexible display device changes (S112), and if yes, the step S104 is returned. If the second object is not displayed on the separation line, the objects are normally displayed without rearranging the objects according to a position of the separation line (S108), and the step S112 is executed. Therefore, the objects displayed on the flexible display device are suitably adjusted according to the current display area, so as to facilitate the user's operation. Exemplary embodiments are provided to describe the displaying method of the disclosure in detail with reference of figures.

FIG. 1B is a block diagram of a flexible display device according to an exemplary embodiment of the disclosure.

Referring to FIG. 1B, the flexible display device 100 includes a display unit 110, a display deformation sensor 120, a processor 130 and a memory 140. The flexible display device 100 can be a foldable display device, a rollable display device, a sliding display device or a scrolling display device, which is not limited by the disclosure.

The display unit 110 is used to display information and can be bended. For example, the display unit 110 can be an organic light emitting diode (OLED), a flexible liquid crystal display (LCD) panel, an electronic paper or other flexible display panel.

The display deformation sensor 120 is used to detect an operation performed on the flexible display device 100 or deformation of the display unit 110. For example, the display deformation sensor 120 is a pressure sensor, and when a user bends or touches the flexible display device 100, the display deformation sensor 120 detects a corresponding pressure value. Moreover, in another embodiment, the display deformation sensor 120 may also be a bending sensor, and is used to detect a bending operation performed on the flexible display device 100. However, more display deformation sensors 120 may be disposed on the flexible display device 100, which is not limited by the disclosure.

The processor 130 is used to control a whole operation of the flexible display device 100. In the present exemplary embodiment, the processor 130 is a central processing unit (CPU). However, the processor 130 may also be a microprocessor, a digital signal processor (DSP), a programmable controller, an application specific integrated circuit (ASIC), a programmable logic device (PLD) or other similar device.

The memory 140 is used to store data or program codes. For example, the memory 140 may be a synchronous dynamic random access memory (SDRAM), a dynamic random access memory (DRAM), a static random access memory (SRAM), a magnetoresistive random access memory (MRAM), a chache RAM, a synchronous dynamic random access memory (SDRAM), a NOR flash, an embedded DRAM (eDRAM) or other memory.

In the present exemplary embodiment, the memory 140 stores a detection module 142, a calculation module 144 and a display module 146 implemented by program codes.

Processor 130 executes the program code of the display module 146 to display one or a plurality of objects in a display area of the flexible display device 100. These objects can be characters, images, videos or icons of application programs, which is not limited by the disclosure.

The processor 130 receives signals from the display deformation sensor 120, and executes the program code of the detection module 142 to detect a display mode of the flexible display device 100, and executes the program code of the calculation module 144 to generate display mode information according to change of the display mode. In the present exemplary embodiment, the display mode can be a full area display, a partial area display, a planar area display or a curved area display. For example, when the flexible display device 100 is curled to a curved state from a planar state, the display mode is changed from the full area display to the curved area display. Alternatively, when the flexible display device 100 is folded in half, the display mode is changed from the full area display to the partial area display. The display mode information can be a display area size, a display area position, a planar area position or a curved area position. For example, the processor 130 calculates different curved area positions according to different bending degrees of the flexible display device 100. Alternatively, the processor 130 calculates different display area sizes, display area positions and planar area positions according to folding line positions of the folded flexible display device 100.

Particularly, the processor 130 determines whether an object is displayed on a separation line according to the display mode information. If the object is displayed on the separation line, the processor 130 rearranges the objects in the display area according to the display mode information, so as to avoid displaying the objects on the separation line.

In the present exemplary embodiment, the detection module 142, the calculation module 144 and the display module 146 are implemented by computer program codes, and following description of the operations executed by the detection module 142, the calculation module 144 and the display module 146 is, for example, implemented as the processor executes the program codes of the modules. However, the disclosure is not limited thereto. In another embodiment, the detection module 142, the calculation module 144 and the display module 146 can be implemented as one or a plurality of logic gates or circuits to become a detection circuit, a calculation circuit and a display circuit. Whether the detection module 142, the calculation module 144 and the display module 146 are implemented by software or hardware is not limited by the disclosure.

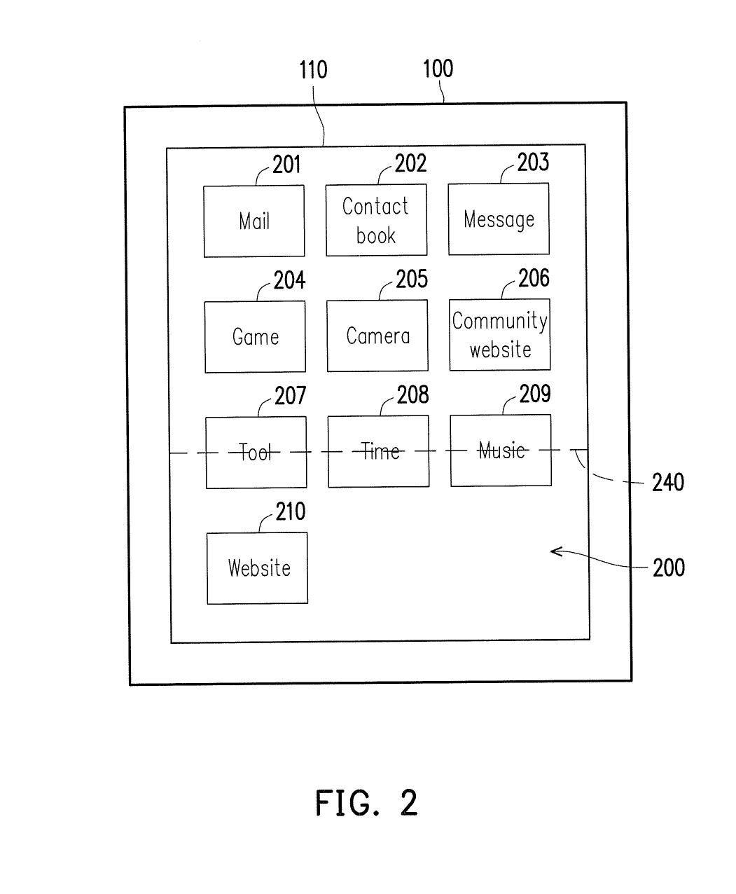

FIG. 2 is a schematic diagram of a bended flexible display device according to an exemplary embodiment of the disclosure.

Referring to FIG. 2, the display unit 110 provides a display area 200, and the display module 146 displays a plurality of objects 201-210 on the display area 200. For example, the objects 201-210 are icons of application programs.

When the user folds the flexible display device 100 in half, the detection module 142 detects a bending operation performed on the flexible display device 100 according to a signal received from the display deformation sensor 120. Moreover, the calculation module 144 obtains a separation line 240 on the display area 200 according to the bending operation. Here, the separation line 240 is generated when the user folds the flexible display device 100 in half.

Particularly, in the present exemplary embodiment, the display module 146 determines whether the objects 201-210 are displayed on the separation line 240. For example, it is assumed that the objects 207-209 are displayed on the separation line 240, which may result in a fact that the objects 207-209 are not easy to be viewed or touched. Therefore, when it is determined that the objects 207-209 are displayed on the separation line 240, the display module 146 rearranges the objects 201-210 according to the separation line so as to avoid displaying the objects 201-210 on the separation line 240. Note that if the objects 201-210 are displayed in a folding region of the separation line 240, it is also determined that the objects 201-210 are displayed on the separation line 240. The folding region is defined as an area near to the separation line 240 where the objects 201-210 are displayed with some distortions. In other words, if an object is to be displayed with distortion, the object is rearranged.

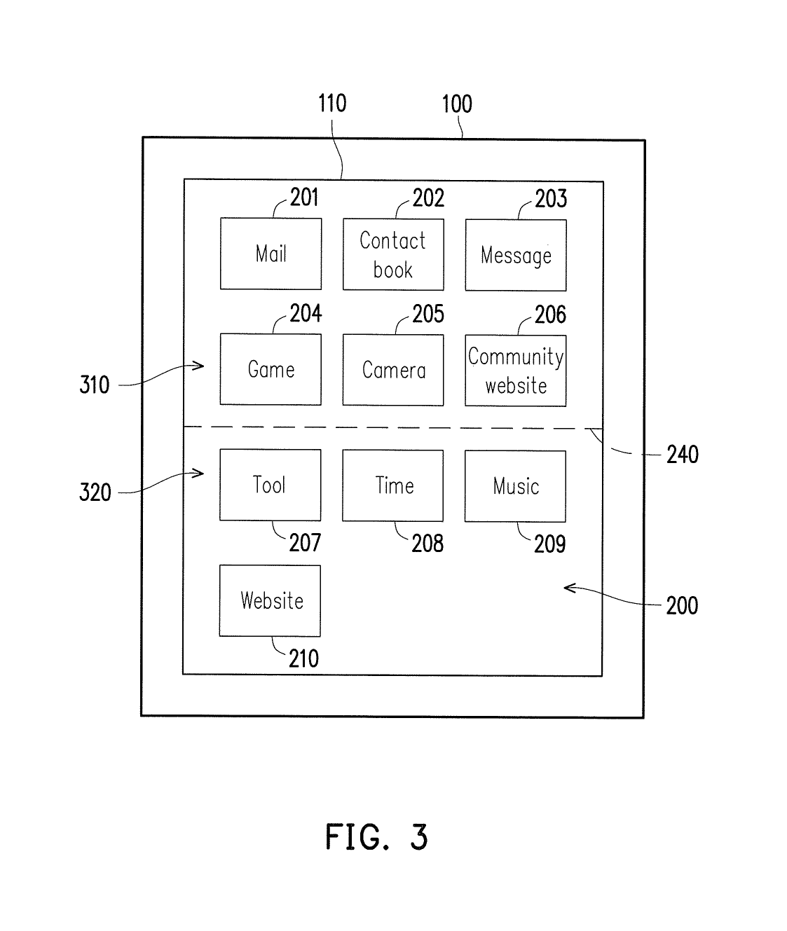

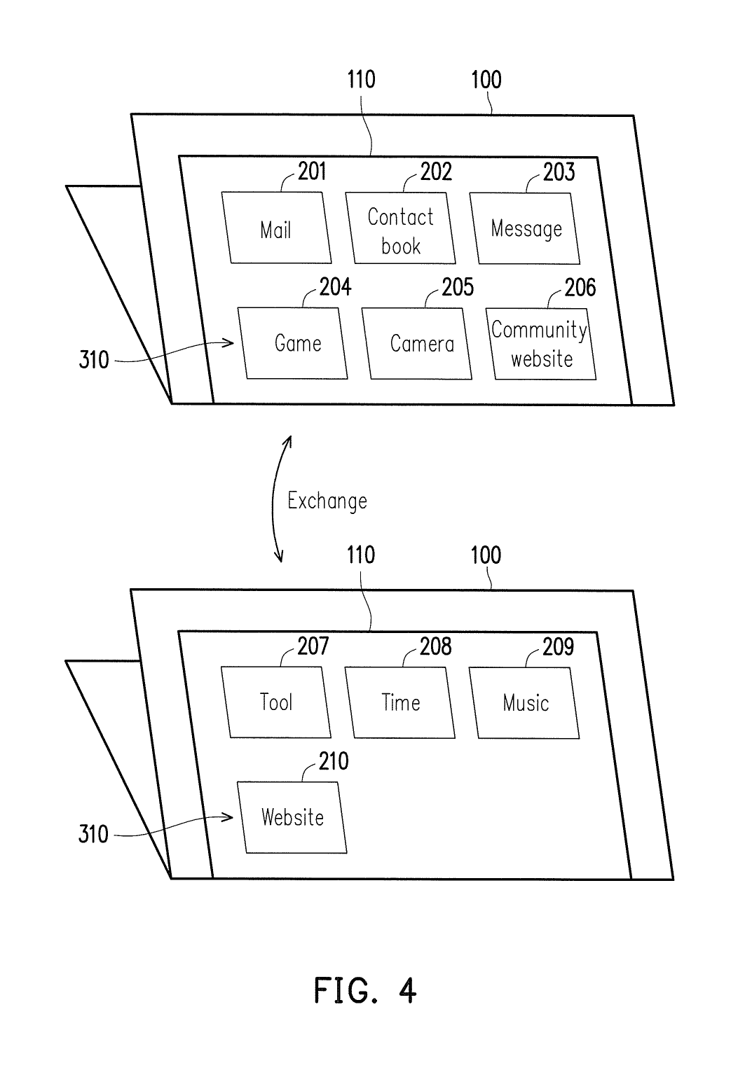

FIG. 3 and FIG. 4 are schematic diagrams of rearranging objects according to an exemplary embodiment of the disclosure.

Referring to FIG. 3, a method of rearranging the objects 201-210 is to move the object 201-210. For example, the display module 146 divides the display area 200 into two sub areas 310 and 320 according to the separation line 240, and the separation line 240 is neither in the sub area 310 nor in the sub area 320. Moreover, the display module 146 displays the objects 201-206 on the sub area 310, and moves the objects 207-210 to the sub area 320. For example, the sub areas 310 and 320 are two windows. Since the separation line 240 is not located on the sub areas 310 and 320, the objects 201-210 displayed in the sub areas 310 and 320 are not located on the separation line 240.

In another exemplary embodiment, the display module 146 may also change sizes of the objects 201-210, or distances between the objects 201-210 to avoid displaying the 201-210 on the separation line 240. Alternatively, when the display module 146 determines that the objects 207-209 are displayed on the separation line 240, the objects 207-209 can be rearranged by the user. For example, the user sends a rearranging instruction (for example, to move the objects 207-210), and the display module 146 rearranges the objects 201-210 according to the rearranging instruction sent by the user and the separation line 240.

Referring to FIG. 4, after the user bends the flexible display device 100, the display unit 110 provides front and back display areas (the sub areas 310 and 320). When the user wants to switch contents in the two display areas, the user sends a switch instruction (for example, by performing a touch gesture or clicking an ion displayed on the display area). After the display module 146 receives the switch instruction, the display module 146 exchanges the objects 201-206 in the sub area 310 and the objects 207-209 in the sub area 320.

In another exemplary embodiment, based on the bending operation performed on the flexible display device 100 by the user, the calculation module 144 calculates two or more separation lines. The display module 146 divides the display area 200 into three or more sub areas according to the separation lines, and the separation lines are not located in any of the sub areas. Moreover, the display module 146 moves each of the objects 201-210 to one of the sub areas. In addition, when the switch instruction sent by the user is received, the objects in two of the sub areas are exchanged. The number of the sub areas is not limited by the disclosure, and which two sub areas with exchanged objects are not limited by the disclosure.

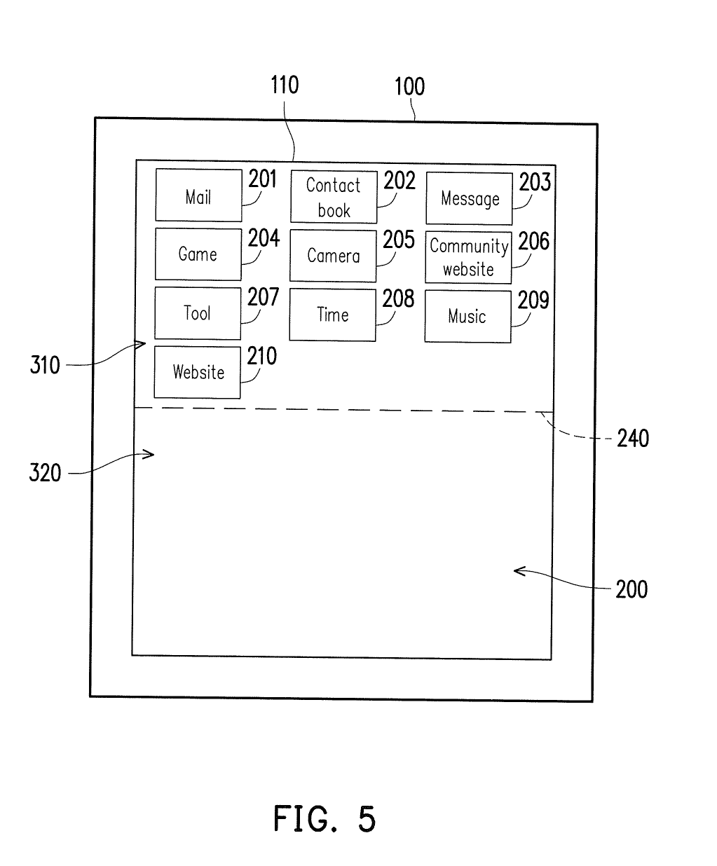

FIG. 5 is a schematic diagram of moving all of the objects to a same sub area according to an exemplary embodiment of the disclosure.

Referring to FIG. 5, in an exemplary embodiment, the display module 146 moves all of the objects 201-210 to the sub area 310. Moreover, the display module 146 also adjusts the sizes of the objects 201-210 (which are also referred to as third objects) according to a size of the sub area 310, so as to suitably display the objects 201-210 in the sub area 310.

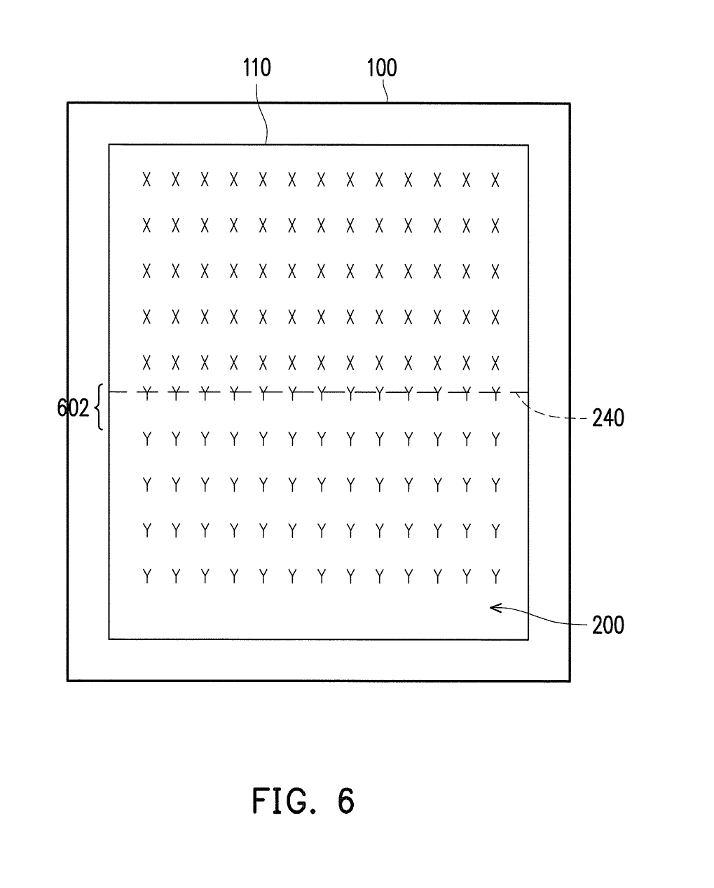

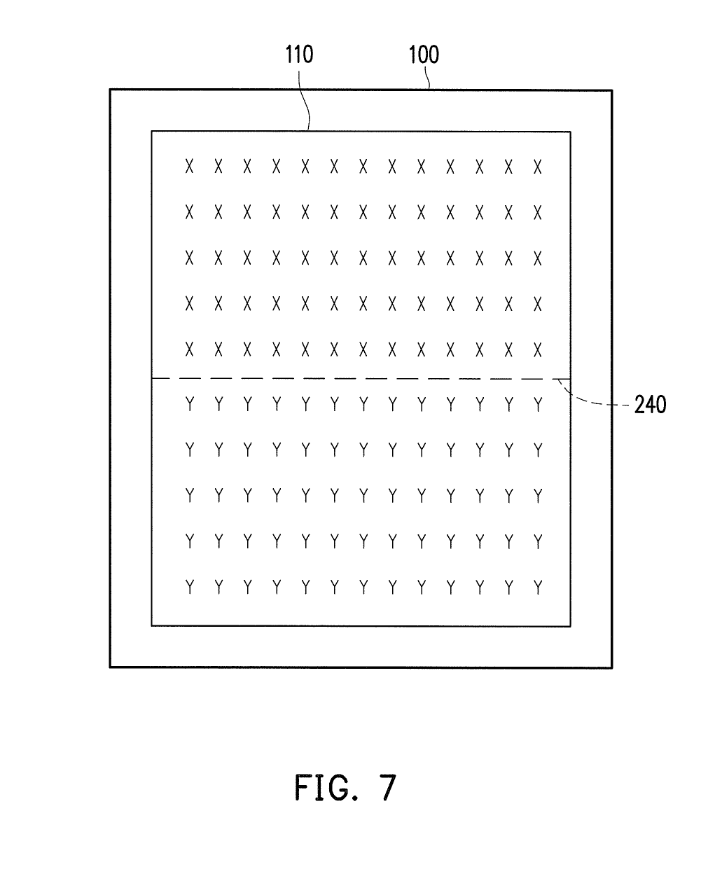

FIG. 6 and FIG. 7 are schematic diagrams of objects implemented as characters according to an exemplary embodiment of the disclosure.

Referring to FIG. 6, the objects displayed on the display area 200 are characters, and the characters 602 are displayed on the separation line 240. Therefore, the display module 146 rearranges at least a part of the characters. For example, the display module 146 moves a part of the characters in the display area 200 downwards (shown in FIG. 7). In another exemplary embodiment, the display module 146 may change the size of the characters or a line spacing (a distance between lines), such that none of the characters is displayed on the separation line 240.

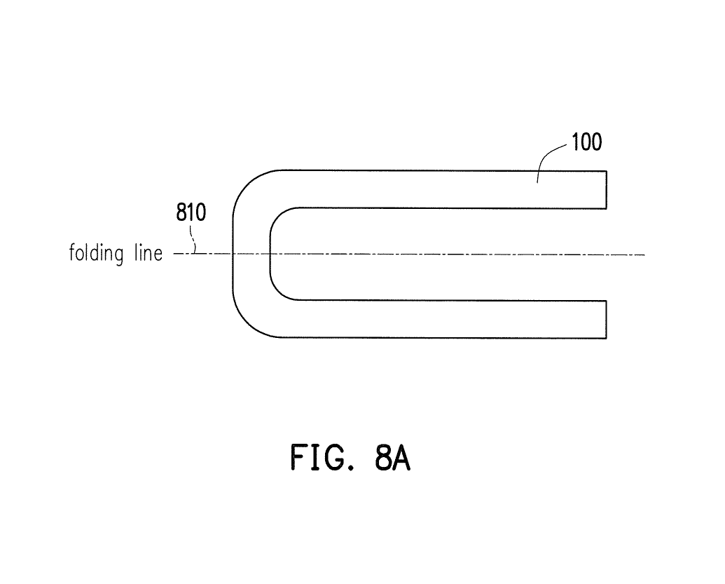

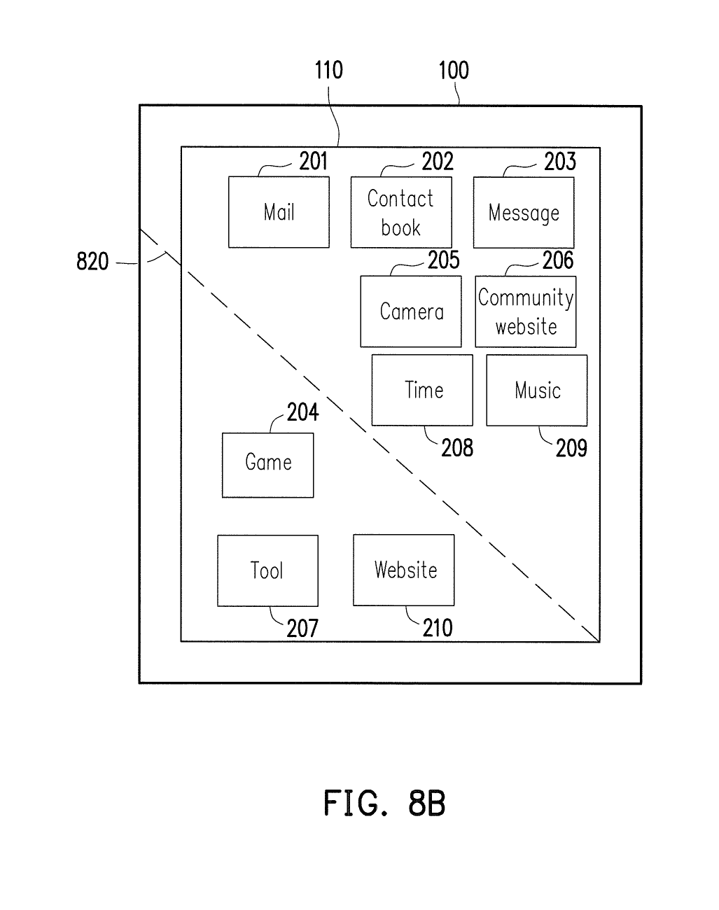

FIG. 8A and FIG. 8B are schematic diagrams illustrating a situation when the flexible display device is bended according to an exemplary embodiment of the disclosure.

Referring to FIG. 8A, when the user bends the flexible display device 100, the calculation module 144 calculates a separation line 810 (which is also referred to as a folding line). For example, the calculation module 144 obtains a pressure distribution of the flexible display device 100 through the display deformation sensor 120, and calculates the separation line 810 according to the pressure distribution. Moreover, in another exemplary embodiment, if the user only bends a corner of the flexible display device 100, the calculation module 144 can also calculate the corresponding separation line. A type of the bending operation is not limited by the disclosure.

In an embodiment, according to the way that the user bends the flexible display device 100, the separation line 810 and any side of the flexible display device 100 may form an included angle of any value. Alternatively, the separation line can be a curve of any curvature or an irregular line segment. Length, angle, curvature, start point and end point of the separation line 810 is not limited by the disclosure. For example, referring to FIG. 8B, when the flexible display device 100 is bent along the separation line 820, the objects 201-210 are rearranged, such that the objects 201-210 are not displayed on the separation line 820. In the embodiment of FIG. 8B, the display module 146 closely arranges the objects 208-209, so as to avoid displaying the objects 201-210 on the separation line 820. However, in other embodiments, the display module 146 may change a size of a part of the objects 201-210 to avoid displaying the objects 201-210 on the separation line, though the disclosure is not limited thereto.

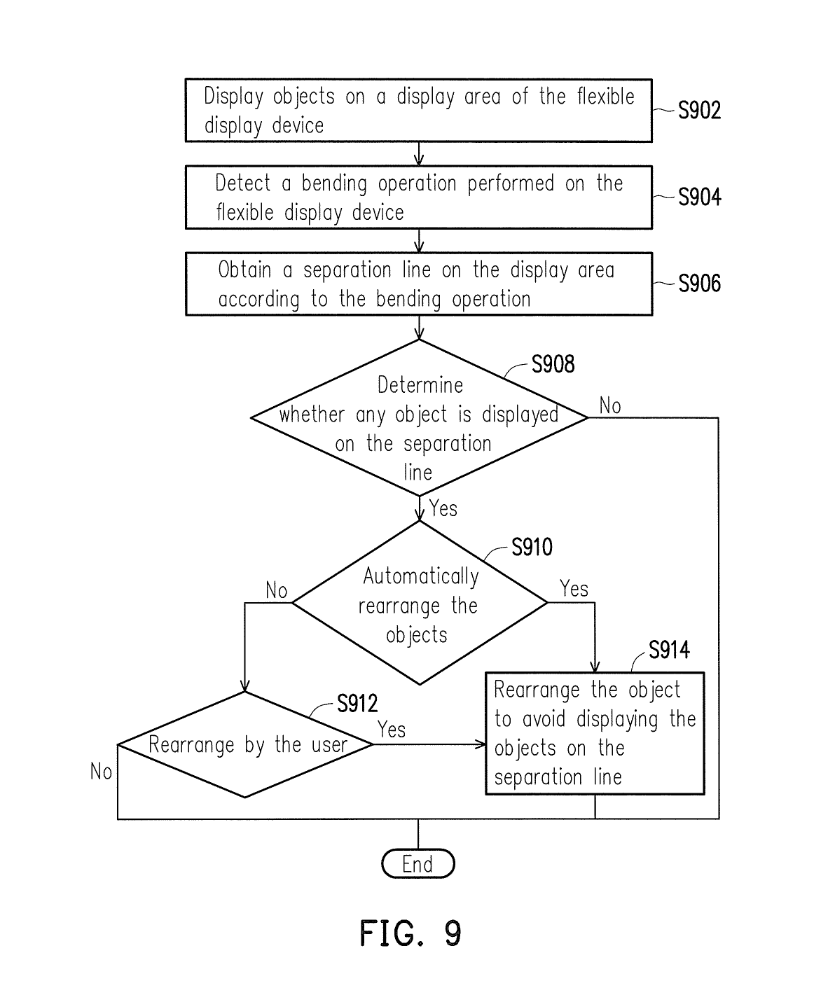

FIG. 9 is a flowchart illustrating a displaying method according to an exemplary embodiment of the disclosure.

In step S902, the display module 146 displays objects on a display area of the flexible display device.

In step S904, the detection module 142 detects a bending operation performed on the flexible display device. Moreover, in step S906, the calculation module 144 obtains a separation line on the display area according to the bending operation.

In step S908, the display module 146 determines whether any object is displayed on the separation line.

If any object is displayed on the separation line, in step S910, the display module 146 determines whether to automatically rearrange the objects. In detail, the user can set the flexible display device 100 whether to automatically rearrange the objects according to an actual requirement. For example, the flexible display device 100 may have a switch that can be selectively activated, and the user can operate the switch to activate or deactivate the function of automatically rearranging the objects.

If it is unnecessary to automatically change the display mode of the objects, in step S912, the display module 146 determines whether the objects are to be rearranged by the user. If yes, the display module 146 receives a rearranging instruction from the user, and executes a following step S914 according to the rearranging instruction.

If it is required to automatically change the display mode of the objects, in the step S914, the display module 146 rearranges the objects according to the separation line, so as to avoid displaying the objects on the separation line. The method of rearranging the objects has been described in detail with reference of figures, and details thereof are not repeated.

It should be noticed that, in the present exemplary embodiment, although the user can set whether the flexible display device 100 to automatically rearrange the displayed object according to an actual requirement, the disclosure is not limited thereto. For example, in another exemplary embodiment, when any object is displayed on the separation line, the display module 146 rearranges the objects according to the separation line to avoid displaying the objects on the separation line. Namely, the aforementioned step S910 and the step S912 can be omitted.

In summary, the displaying method and the flexible display device of the disclosure can suitably rearrange the objects when the flexible display device is bended, so that the objects are not appeared at the bending portion.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A displaying method of a flexible display device, comprising:
displaying at least one object on a display area of the flexible display device;
detecting a display mode of the flexible display device to generate display mode information;
determining whether at least one second object in the at least one object is displayed on a separation line according to the display mode information;
rearranging the at least one object on the display area according to the display mode information when the at least one second object is displayed on the separation line, so as to avoid displaying the at least one object on the separation line.

2. The displaying method of the flexible display device as claimed in claim 1, wherein the step of detecting the display mode of the flexible display device to generate the display mode information comprises:
detecting a bending operation performed on the flexible display device, and obtain the separation line on the display area according to the bending operation.

3. The displaying method of the flexible display device as claimed in claim 1, wherein the step of rearranging the at least one object on the display area according to the display mode information comprises:
dividing the display area into a plurality of sub areas according to the separation line, wherein the separation line is not located on the sub areas; and
moving the at least one object to one of the sub areas.

4. The displaying method of the flexible display device as claimed in claim 1, wherein a number of the at least one object is plural, and the step of rearranging the at least one object on the display area according to the display mode information comprises:
dividing the display area into a plurality of sub areas according to the separation line, wherein the separation line is not located on the sub areas; and
moving each of the objects to one of the sub areas.

5. The displaying method of the flexible display device as claimed in claim 4, further comprising:
exchanging the objects displayed in two of the sub areas.

6. The displaying method of the flexible display device as claimed in claim 1, wherein the step of rearranging the at least one object on the display area according to the display mode information comprises:
changing a size of at least one third object in the at least one objects to avoid displaying the at least one object on the separation line.

7. The displaying method of the flexible display device as claimed in claim 1, wherein a number of the at least one object is plural, and the step of rearranging the at least one object on the display area according to the display mode information comprises:
changing a distance between the objects to avoid displaying the at least one object on the separation line.

8. The displaying method of the flexible display device as claimed in claim 1, wherein the at least one object is at least one character, at least one icon, at least one image or at least one video.

9. The displaying method of the flexible display device as claimed in claim 1, wherein the flexible display device is a foldable display device, a rollable display device, a sliding display device or a scrolling display device.

10. The displaying method of the flexible display device as claimed in claim 1, wherein the display mode information comprises at least one of a display area size, a display area position, a planar area position and a curved area position.

11. The displaying method of the flexible display device as claimed in claim 1, wherein the display mode comprises at least one of a full area display, a partial area display, a planar area display and a curved area display.

12. A flexible display device, comprising:
a display unit;
a display deformation sensor; and
a processor, coupled to the display unit and the display deformation sensor, and displaying at least one object on a display area of the display unit,
wherein the processor detects a display mode of the flexible display device through the display deformation sensor to generate display mode information,
wherein the processor determines whether at least one second object in the at least one object is displayed on a separation line according to the display mode information, and
when the at least one second object is displayed on the separation line, the processor rearranges the at least one object on the display area according to the display mode information, so as to avoid displaying the at least one object on the separation line.

13. The flexible display device as claimed in claim 12, wherein the processor detects a bending operation through the display deformation sensor, and obtains the separation line on the display area according to the bending operation.

14. The flexible display device as claimed in claim 12, wherein the processor divides the display area into a plurality of sub areas according to the separation line, and moves the at least one object to one of the sub areas, wherein the separation line is not located on the sub areas.

15. The flexible display device as claimed in claim 12, wherein a number of the at least one object is plural,
wherein the processor divides the display area into a plurality of sub areas according to the separation line, and moves each of the at least one object to one of the sub areas,
wherein the separation line is not located on the sub areas.

16. The flexible display device as claimed in claim 15, wherein the processor exchanges the objects displayed in two of the sub areas.

17. The flexible display device as claimed in claim 12, wherein the processor changes a size of at least one third object in the at least one objects to avoid displaying the at least one object on the separation line.

18. The flexible display device as claimed in claim 12, wherein a number of the at least one object is plural, and the processor changes a distance between the objects to avoid displaying the at least one object on the separation line.

19. The flexible display device as claimed in claim 12, wherein the at least one object is at least one character, at least one icon, at least one image or at least one video.

20. The flexible display device as claimed in claim 12, wherein the display mode information comprises at least one of a display area size, a display area position, a planar area position and a curved area position.

21. The flexible display device as claimed in claim 12, wherein the display mode comprises at least one of a full area display, a partial area display, a planar area display and a curved area display.
